(19) United States
(12) Patent Application Publication
(10) Pub. No.: US 2009/0071058 A1
(43) Pub. Date: Mar. 19, 2009

(54) Multi-functional fishing box

(76) Inventors: Timothy G. Chavez, Pueblo, CO (US); Richard A. Espinoza, Pueblo, CO (US)

Correspondence Address: LITMAN LAW OFFICES, LTD., POST OFFICE BOX 15035, CRYSTAL CITY STATION, ARLINGTON, VA, 22215-0035, US

(21) Appl. No.: 11/898,573

(22) Filed: Sep. 13, 2007

(51) Int. Cl. A01K 97/06; A01K 97/10

(52) U.S. Cl. 43/54.1; 43/21.2

(57) ABSTRACT

The multi-functional fishing box has a top, a bottom, a back, a front and two sides. The top including a fold down drink holder, a stick on tape measure and two hook and loop fastener patches. The back includes two pole carriers and a pair of hook and loop fastener straps that cooperate with the patches on the top to secure the pole for carrying. The front of the box includes at least one pull out drawer for carrying tackle and a keeper for keeping the drawer within the box. Each side of the box includes a screw-in ring for holding one end of a shoulder strap, a hinge for mounting a rod holder and a support for the rod holder when placed in a position for carrying the box.

### BACKGROUND OF THE INVENTION

1. Field of the Invention

The present invention generally relates to fishing accessories. More specifically the invention relates to a multi-functional fishing box or tackle box.

2. Description of the Relate Art

Fishermen carry a lot of gear from their vehicles to the bank of rivers and lakes. Usually the gear consists of rods, poles, tackle boxes, etc. This may result in multiple trips between the car and the fishing spot, or simply result in considerable inconvenience and the use of both hands to carry the gear to the fishing spot. Moreover, at the fishing site, the tackle box generally goes unused when the line is played out, with the fisherman holding onto the fishing pole. Thus, a multi-functional fishing box solving the aforementioned problems is desired.

### SUMMARY OF THE INVENTION

The multi-functional fishing box of the present invention includes a top, a bottom, a back, a front and two sides sealed with silicone for waterproofing. The top includes a drink holder that can be flipped up for holding drinks and folded down for travel. The top further includes a measuring tape near the back edge for measuring the catch. The top is made of polycarbonate and functions as a cutting board.

Each side contains a screw-in ring for securing a shoulder strap for carrying the box. The shoulder strap has an eyelet, which is used to stake down the box when necessary. Each side also includes a hinge for mounting a PVC rod holder that pivots on the hinge from 0°-60°. Notches are provided in the pipe for holding and stabilizing poles while fishing. The bottom notch is for receiving the neck of a reel, and the top notch is for easy slide and pull out when setting a hook. An aluminum support is provided on each side for supporting the rod holder in a resting position. An eight-inch bungee cord is provided on each side to hold down the hinge and rod holder for transport. The free end of the bungee cord is held to the top by a screw fastener.

The back of the box is provided with a rod carrier and one end of a hook and loop fastener strip. The free end of the hook and loop fastener strip is attached to a mating hook and loop fastener patch mounted on the top of the box. The hook and loop fastener strip is used to hold down the rods in the rod carrier for transport.

The front of the box is provided with a pull handle for a drawer in the box and a pivoting keeper to keep the drawer in the box during transport. A plastic insert is provided in the drawer for tackle that sits inside the box. The front of the box also includes a pair of anchor spots to stake down the box, if needed.

These and other features of the present invention will become readily apparent upon further review of the following specification and drawings.

### BRIEF DESCRIPTION OF THE DRAWINGS

FIG. 1 is an environmental, perspective view of a multi-functional fishing box according to the present invention.

FIG. 2 is a top view of the multi-functional fishing box according to the present invention.

FIG. 3 is perspective view of the fishing box according to the present invention with the drawer exploded therefrom.

FIG. 4 is a rear view of the multi-functional fishing box according to the present invention.

FIG. 5 is a side view of the multi-functional fishing box according to the present invention.

FIG. 6 is a front view of an embodiment of a multi-functional fishing box according to the present invention having two drawers.

FIG. 7 is a front view of a multi-functional fishing box according to the present invention.

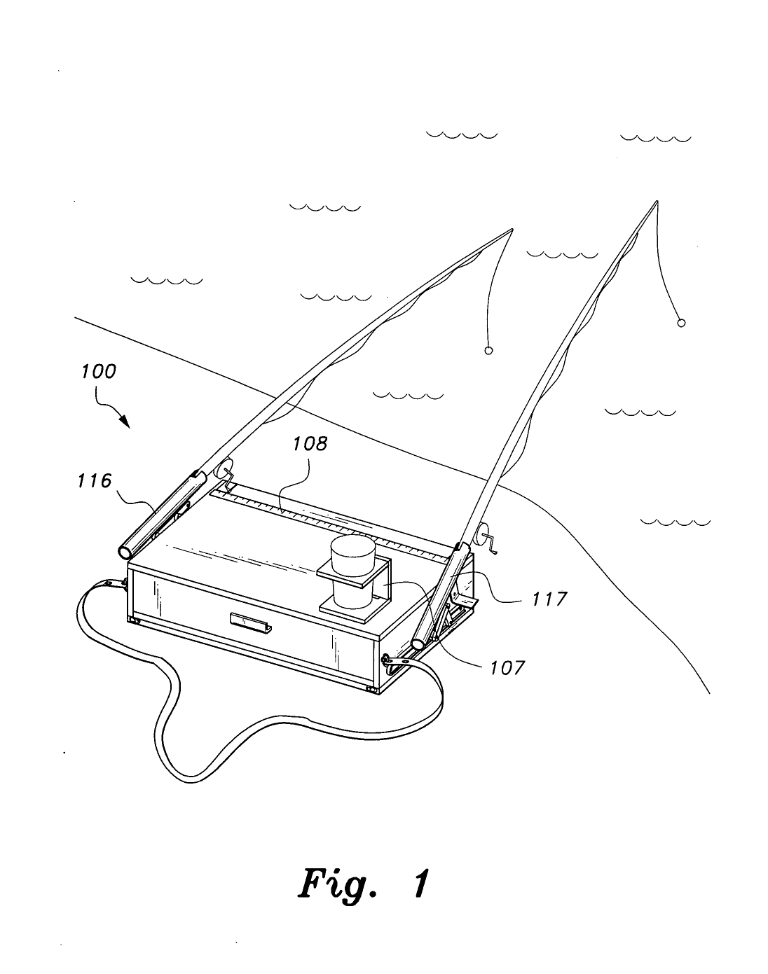

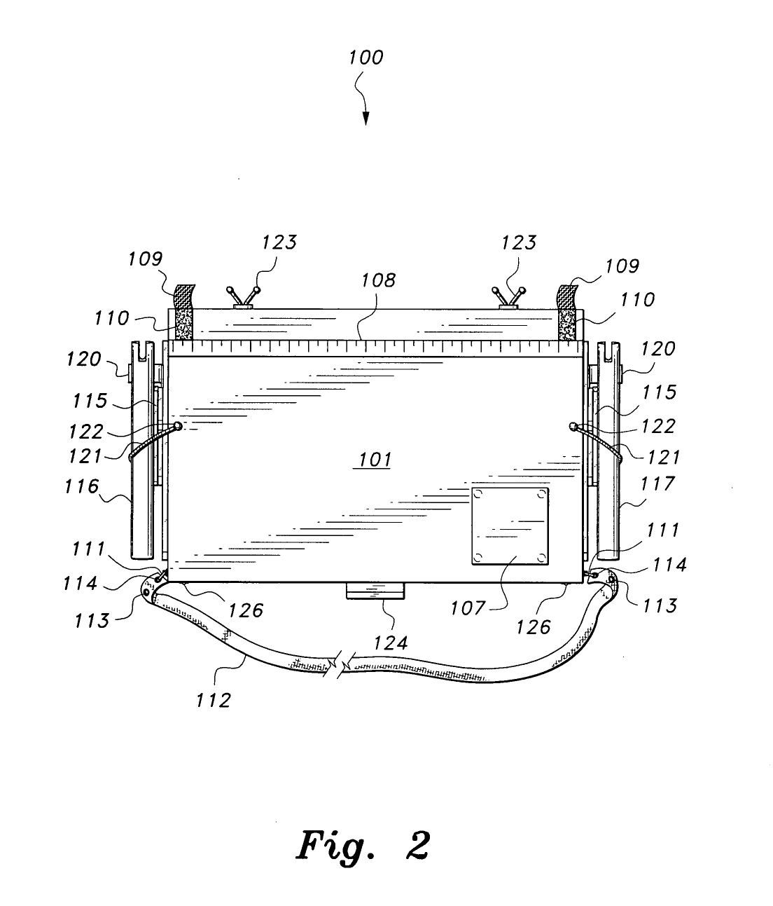

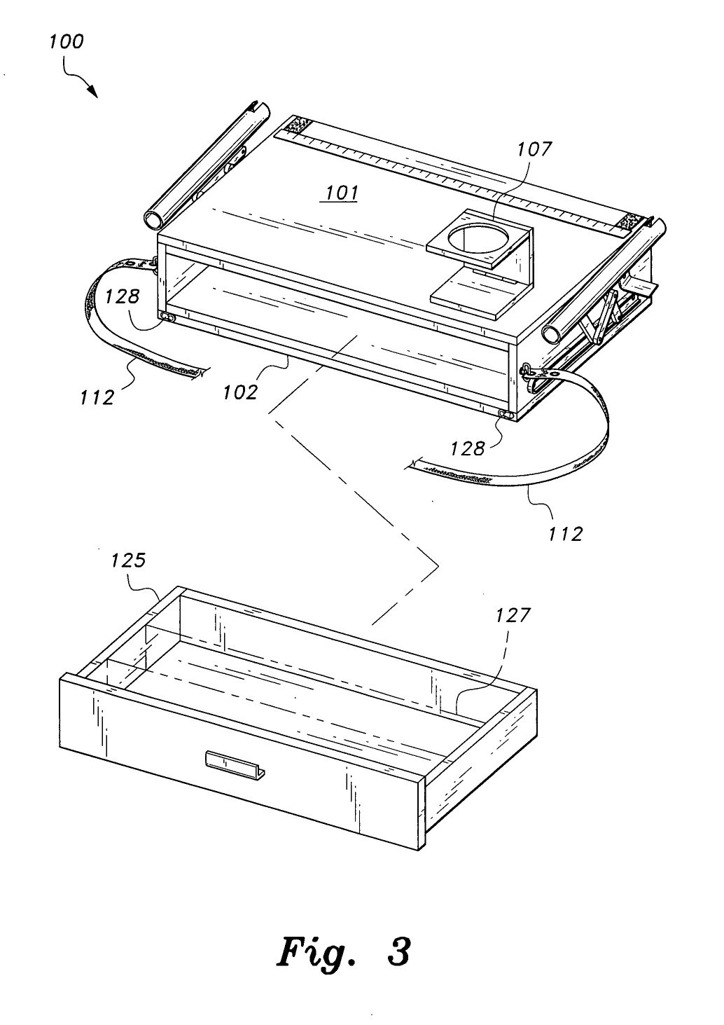

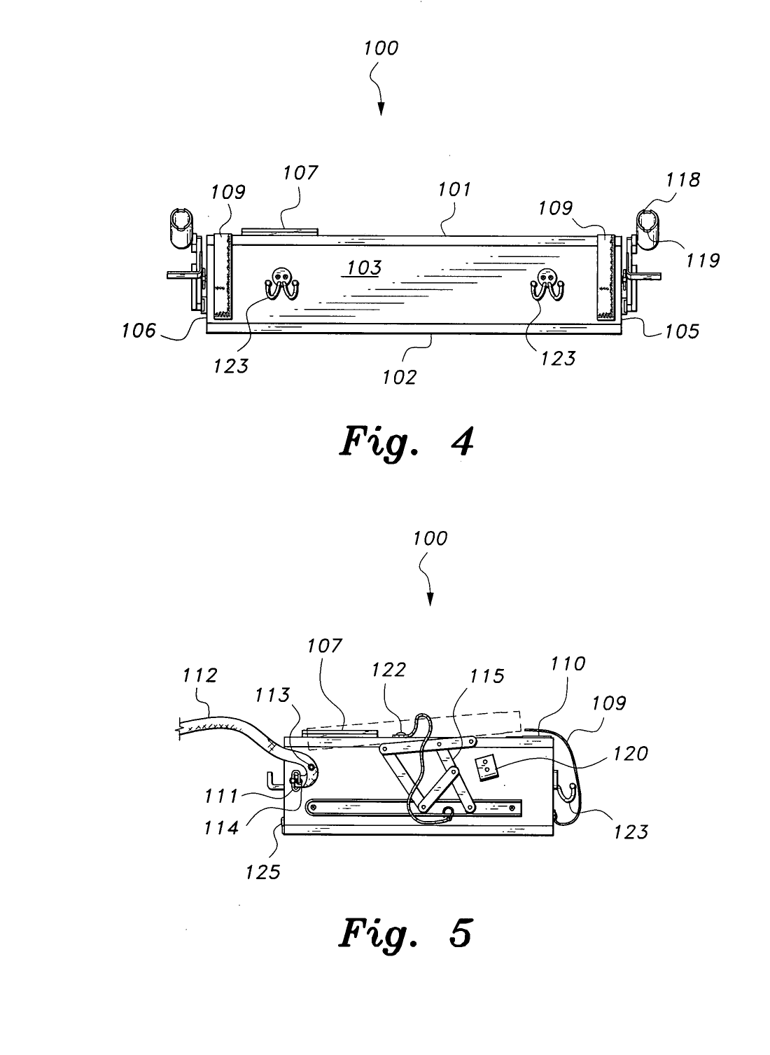

Similar reference characters denote corresponding features consistently throughout the attached drawings.

### DETAILED DESCRIPTION OF THE PREFERRED EMBODIMENTS

The present invention is a box about fourteen inches by 21½ inches by five inches in size and includes a top 101, a bottom 102, a back 103, a front 104 and two sides 105, 106. The box is sealed with silicone for waterproofing. The top 101 includes a drink holder 107 that can be flipped up for holding drinks and folded down for travel. The top 101 further includes a stick-on measuring tape 1 08 near the back edge for measuring the size of a catch and two hook and loop fastener patches, one on each back corner.. The top 101 is formed of a polycarbonate material, such as Lexan®, and functions as a cutting board.

Each side 105,106 contains a screw-in ring 111 for securing a shoulder strap 112 for carrying the box 100. The shoulder strap 112 has an eyelet 113, which is used to stake down the box when necessary, and an eyelet 114 for securing shoulder strap 112 to the screw-in ring 111. Each side also includes a hinge 115 for mounting a polyvinyl chloride (PVC) rod holder 116, 117, respectively, in the form of a 1¼-inch pipe that pivots on the hinge 115 from 0°-60°. Notches 118 and 119 are provided in the pipe for holding and stabilizing poles while fishing. The bottom notch 119 is for receiving the neck of a reel, and the top notch 118 is for easy slide and pull out when setting a hook. An aluminum support 120 is provided on each side for supporting the rod holder in a resting position. An eight-inch bungee cord 121 is provided on each side to hold down the hinge 115 and rod holder for transport. The free end of the bungee cord 121 is held to the top 101 by a screw fastener.

The back 103 of the box 100 is provided with a pair of rod carriers 123 for each side of the back 103, and with one end of a hook and loop fastener strip for each side of the back 103 of the box 100. The free ends of the hook and loop fastener strips are attached to the hook and loop fastener patches mounted on the top 101 of the box 100. The hook and loop fastener strips are used to hold down the rods in the rod carrier 123 for transport.

The front 104 of the box 100 is provided with an aluminum pull handle 124 for a drawer 125 in the box 100 and a pivoting keeper 125 to keep the drawer 125 in the box 100 during transport. A plastic insert 127 is provided in the drawer 125 for tackle that sits inside the box 100. The front 104 of the box 100 also includes a pair of anchor spots 128 to stake down the box if needed.

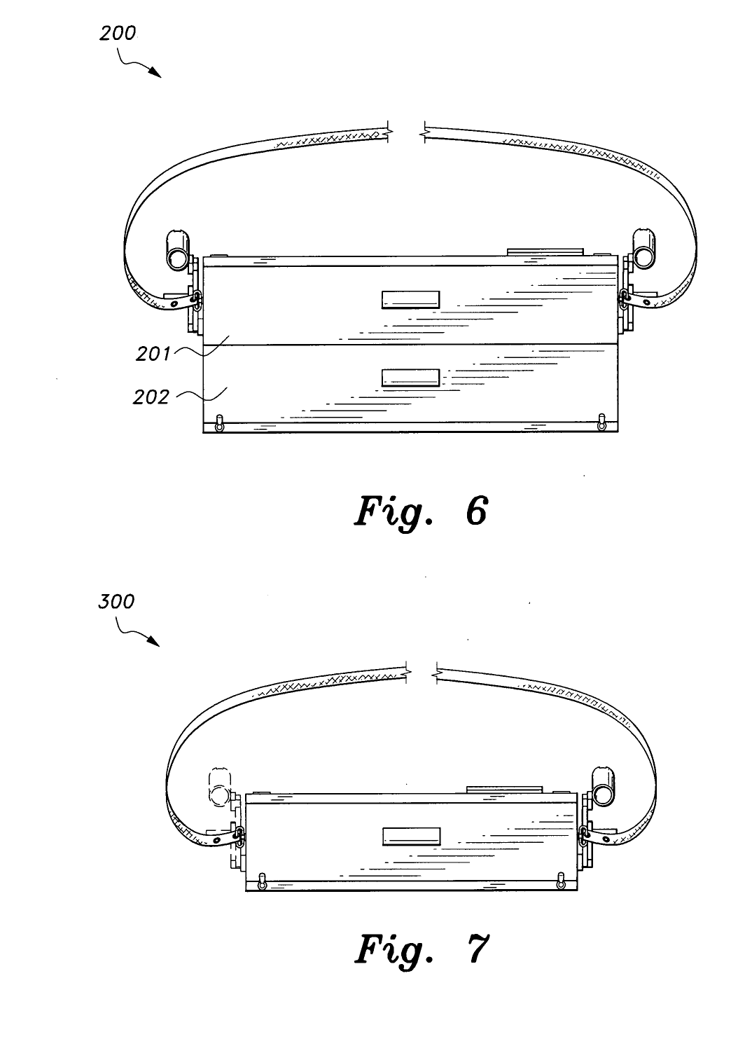

FIG. 6 shows a deluxe box 200 having a first drawer 201 and a second drawer 202 for storing tackle. FIG. 7 shows a junior box 300, which is a smaller version of box 100 having only one pole holder on one side of the box 300.

It is to be understood that the present invention is not limited to the embodiments described above, but encompasses any and all embodiments within the scope of the following claims.

We claim:

1. A multi-functional fishing box, comprising:
a top, a bottom, a back, a front and two sides joined together to form box, the top including a fold down drink holder, a stick on tape measure and two hook and loop fastener patches, the back including two pole carriers and a pair of hook and loop fastener straps cooperating with the patches on the top to secure the pole for carrying;
at least one pull out drawer for carrying tackle slidably mounted in the front of the box and a keeper releasably engaging the drawer for keeping the drawer within the box;
a screw-in ring mounted on each side of the box for holding one end of a shoulder strap, a hinge for mounting a rod holder and a support for the rod holder when placed in a position for carrying the box.

2. The multi-functional fishing box according to claim 1, further comprising a bungee cord on each of the sides of said box for holding down the hinge and said rod holder in the carrying position.

3. The multi-functional fishing box according to claim 1, wherein each of the rod holders includes a notch for holding and supporting a pole while fishing.

4. The multi-functional fishing box according to claim 3, wherein each of the rod holders includes a second notch for holding the neck of a reel.

5. The multi-functional fishing box according to claim 1, wherein the top is made of polycarbonate for use as a cutting board.

6. The multi-functional fishing box according to claim 1, wherein the box is sealed with a silicone sealant for waterproofing.

7. The multi-functional fishing box according to claim 1, wherein the front of said box includes two anchor spots for staking down the box.

8. The multi-functional fishing box according to claim 1, wherein said at least one pull out drawer comprises two drawers.

9. The multi-functional fishing box according to claim 1, further comprising a plastic insert for tackle disposed within the at least one drawer.
